(19) United States
(12) Patent Application Publication
(10) Pub. No.: US 2023/0069121 A1
(43) Pub. Date: Mar. 2, 2023

(54) JAR WITH BIOMETRIC LOCK

(71) Applicant: Emily Lenora Wood, Charleston, SC (US)

(72) Inventor: Emily Lenora Wood, Charleston, SC (US)

(21) Appl. No.: 17/805,544

(22) Filed: Jun. 6, 2022

Related U.S. Application Data
(60) Provisional application No. 63/260,593, filed on Aug. 26, 2021.

(51) Int. Cl. B65D 55/14; G07C 9/26

(52) U.S. Cl. CPC B65D 55/14; G07C 9/26

(57) ABSTRACT

A locking jar includes a biometric sensor on a lid of the jar electronically connected to a lock assembly, housed within the lid and at least one deadbolt, for movement between an extended position and a retracted position, connected to the lock assembly. The extended position of the deadbolt protrudes from the lid and into a cove underneath a lip of the jar. The deadbolt retracts from the extended position to the retracted position by a user activating the biometric sensor with a fingerprint.

### CROSS-REFERENCE TO RELATED APPLICATION

This application claims the benefit of priority of U.S. provisional application No. 63/260,593, filed Aug. 26, 2021, the contents of which are herein incorporated by reference.

### BACKGROUND OF THE INVENTION

The present invention relates to a jar and, more particularly, to a jar with a biometric lock.

Jars, such as cookie jars, are constantly being accessed when they should not be. Cookies and other treats in said jars are being eaten when they should not be. Any person can access the contents of a non-locking jar at any time, resulting in frequent theft and unauthorized consumption of cookies. Unfettered access to cookie jars leads to diets being broken, unwanted weight gain, children consuming too much sugar, and intended consumers deprived of the contents.

Traditional locks require a key or a code to be memorized. This often results in the key or the code being lost, forgotten or stolen.

A cookie jar is used as a storage container for cookies, treats, sweets and other edible items. This designated storage can be an obvious place for unauthorized individuals to look for contraband snacks making this an unprotected target. The treats intended for consumption by one individual can easily be absconded by another.

Existing cookie jars do not provide any restriction to access the contents of the jar. Any individual can add, remove, or tamper with the contents by simply lifting the lid and detaching it from the jar.

As can be seen, there is a need for a locking cookie jar that does not require a key or the memorization of a number.

### SUMMARY OF THE INVENTION

In one aspect of the present invention, a locking jar comprises a biometric sensor on a lid of the jar, electronically connected to a lock assembly, housed within the lid and at least one deadbolt, for movement between an extended position and a retracted position, connected to the lock assembly wherein the extended position of the at least one deadbolt protrudes from the lid and into a cove underneath a lip of the jar wherein the at least one deadbolt retracts from the extended position to the retracted position by a user activating the biometric sensor with a fingerprint.

These and other features, aspects and advantages of the present invention will become better understood with reference to the following drawings, description, and claims.

### BRIEF DESCRIPTION OF THE DRAWINGS

FIG. 1 is a top perspective view of a jar with a biometric lock according to an embodiment of the present invention;

FIG. 2 is a top perspective view of a lid thereof;

FIG. 3 is a front view of the lid thereof;

FIG. 4 is an exploded view of the lid thereof;

FIG. 5 is a cross sectional view showing the jar with a biometric lock in a locked position;

FIG. 6 is a cross sectional view showing the jar with a biometric lock in a unlocked position;

FIG. 7 is a cross sectional view taken on line 7-7 of FIG. 5; and

FIG. 8 is a cross sectional view taken on line 8-8 of FIG. 6.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a jar, such as a cookie jar with a biometric lock and a method of unlocking a jar with a biometric lock.

The jar may comprise at least one slot or cove. The slot or the cove may be underneath a lip of the jar. The slot or the cove may accommodate a deadbolt or a first end of a deadbolt. The slot or cove may accommodate multiple deadbolts. There may be multiple slots or coves.

A lid may rest on top of the jar. The lid may comprise a biometric sensor on a surface or top of the lid. In some embodiments, the biometric sensor is a fingerprint scanner. A mechanical lock may also be used.

The biometric sensor may be electronically connected to a lock assembly. The lock assembly may be housed within the lid. The lock assembly, or a component within the lock assembly, may rotate upon activation of the biometric sensor. The rotation may cause a movement of the deadbolt to extend to an extended position or retract to a retracted position.

When the lid is on a top surface of the jar and the deadbolt is in an extended position, the deadbolt fits into a slot or cove in the jar, locking the lid to the jar. This prevents the lid from being removed from the jar. The deadbolt may be unlocked by a user activating the biometric sensor. Activating the biometric sensor may cause the deadbolt to shift or retract to a retracted position.

In some embodiments, the deadbolt extend and protrude from the lid of the jar when in an extended position. In some embodiments, the deadbolt fits into the housing of the lid when in the retracted position.

An alarm may be connected to the lid, the jar, or the biometric sensor. The alarm may sound an alert when a user unsuccessfully attempts to unlock the lock or may sound an alert when a user attempts to force open the jar without unlocking the lock. The alarm may send a notification to a device such as a smartphone.

In some embodiments, the lock may be powered by a battery. The battery may be stored in a housing of the lid. Electronic components such as components for the lock may be housed within the lid.

In some embodiments, the biometric sensor may be powered by the insertion of a charger, such as a USB adaptor, into an outlet, such as a USB outlet. The outlet may be located on the lid of the jar.

A material of the jar is not particularly limited by the present invention. The material may be plastic, metal, ceramic, or any material suitable for a jar.

A gasket, such as a silicone seal, may be placed in between the lid and the jar to form an airtight seal.

In some embodiments, a writing surface is sealed or affixed to an outside surface of the jar. The writing surface may be a chalk board, a white board, blackboard paint painted onto the jar, or any material suitable for writing.

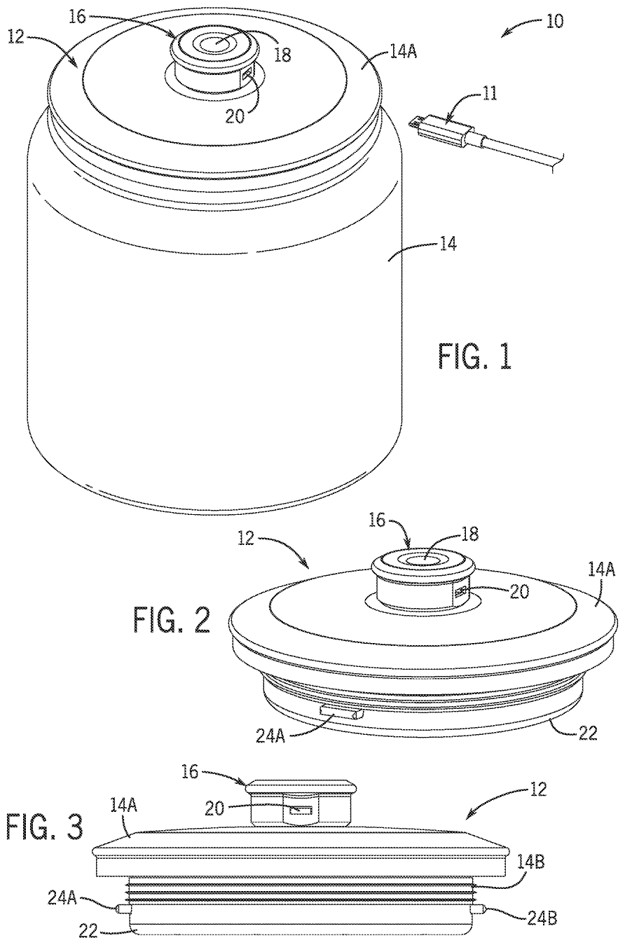

Referring now to the Figures, FIG. 1 is a biometric locking jar 10 according to an embodiment of the present invention. A lid 12 fits on a top end of a jar 14. The lid includes a biometric sensor 16 with a fingerprint reading surface 18. The lid 12 also includes a charging port 20 to accommodate a charger 11.

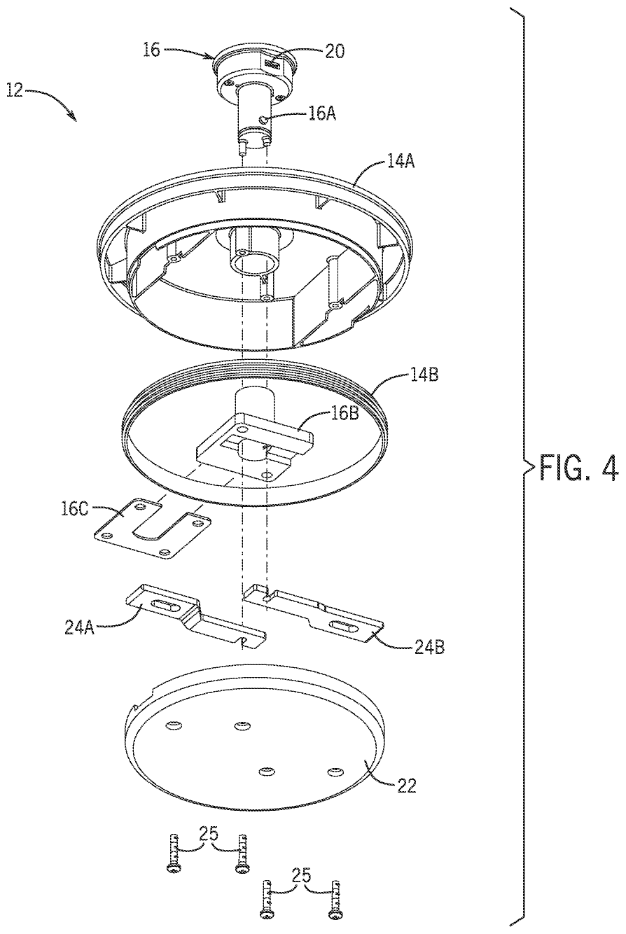

FIGS. 2-4 show additional perspectives of the lid 12 according to an embodiment of the present invention. The biometric sensor 16 fits through a top shell 14A and into a lock assembly 16B. A lock retainer 16C. is attached to the lock assembly 16B. A lower deadbolt 24A and an upper deadbolt 24B attach to the lock assembly 16B. Fasteners 25 fasten a lower cap 22 to the top shell 14A, enclosing the lock assembly 16B and the lock retainer 16C within. A gasket 14B fits snugly on an outer edge of the top shell 14A. The gasket 14B forms an airtight seal when the lid 12 is placed on top of the jar 14.

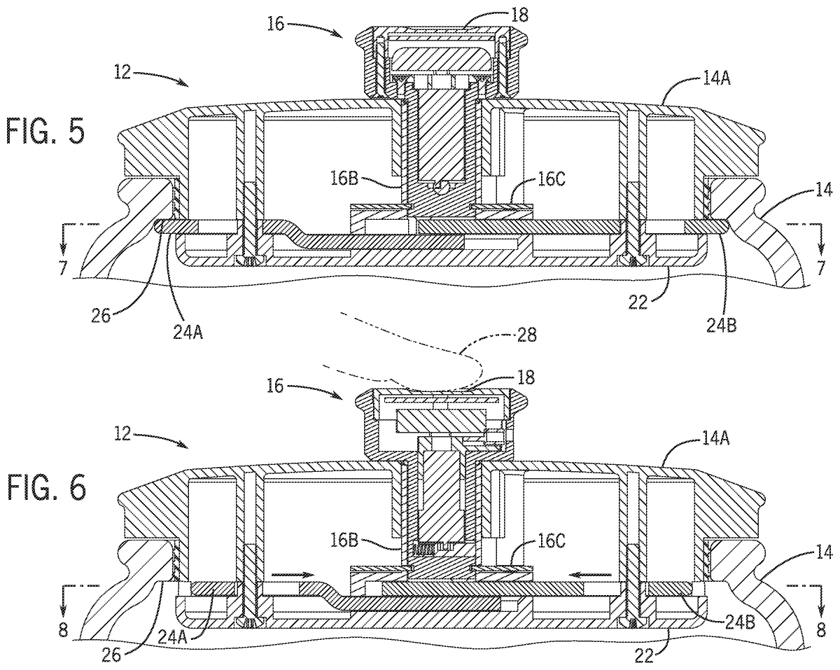

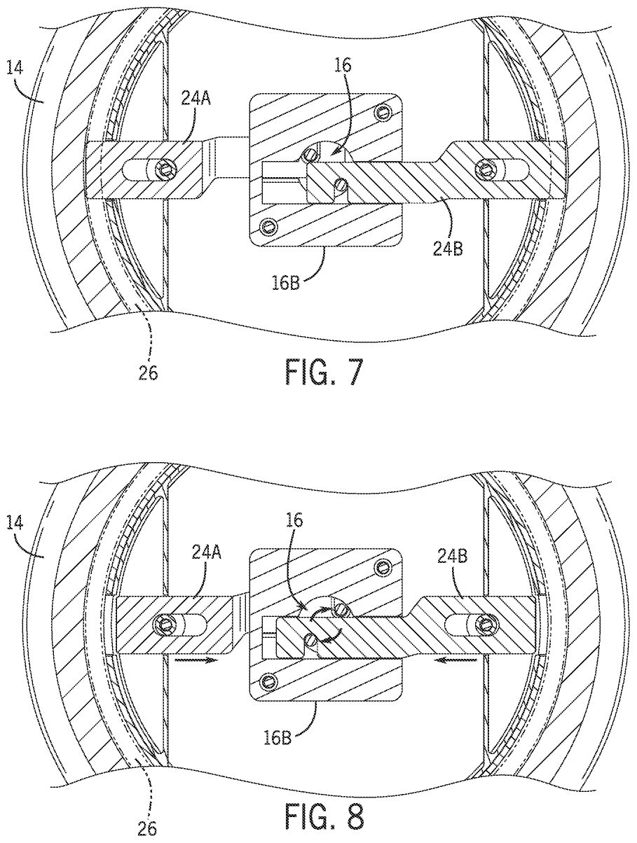

FIGS. 5-8 detail a locking function of the biometric locking jar 10 according to an embodiment of the present invention. When the lid 12 is placed on top of the jar 14, a user may lock the biometric locking jar 10 causing the lower deadbolt 24A and the upper deadbolt 24B to extend into a cove 26 beneath a lip of the jar 14 (as best seen in FIGS. 5 and 7). This prevents the lid 12 from being removed from the jar 14. A user unlocks the biometric locking jar 10 by placing a finger 28 on the fingerprint reading surface 18 (as best seen in FIG. 6). This will cause the lower deadbolt 24A and the upper deadbolt 24B to retract from the cove 26 of the jar 14, effectively unlocking the biometric locking jar 10.

It should be understood, of course, that the foregoing relates to exemplary embodiments of the invention and that modifications may be made without departing from the spirit and scope of the invention as set forth in the following claims.

What is claimed is:

1. A locking jar comprising:
a biometric sensor on a lid of the jar electronically connected to a lock assembly, housed within the lid; and
at least one deadbolt, for movement between an extended position and a retracted position, connected to the lock assembly;
wherein the extended position of the at least one deadbolt protrudes from the lid and into a cove underneath a lip of the jar;
wherein the at least one deadbolt retracts from the extended position to the retracted position by a user activating the biometric sensor with a fingerprint.

2. The locking jar of claim 1, further comprising a writing surface affixed to an outside surface of the jar.

3. The locking jar of claim 1, further comprising an alarm.

4. The locking jar of claim 1, further comprising a charging port on the lid to power a battery housed within the lid.

5. The locking jar of claim 1, further comprising a gasket on an outer edge of the lid, forming a seal between the lid and the jar.

6. A method of unlocking a cookie jar comprising:
placing a finger on a biometric sensor on a top surface of a lid of the jar;
rotating a component of a lock assembly housed within the lid of the jar;
removing a first end of a deadbolt from a cove underneath a lip of the jar; and
removing the lid from the jar.
